(19) United States
(12) Patent Application Publication
(10) Pub. No.: US 2025/0173717 A1
(43) Pub. Date: May 29, 2025

(54) SYSTEMS AND METHODS FOR TRANSACTION PROCESSING

(71) Applicant: GRATIFY PAYMENTS INC., North Vancouver (CA)

(72) Inventors: Christopher Everett BAILEY, Fort Langley (CA); Randy LUKASHUK, Errington (CA); Pawel ZEBROWSKI, Coquitlam (CA); Robert DUBECKY, Vancouver (CA); Harmandeep Singh SANDHU, Surrey (CA)

(73) Assignee: GRATIFY PAYMENTS INC., North Vancouver (CA)

(21) Appl. No.: 18/934,795

(22) Filed: Nov. 1, 2024

Related U.S. Application Data
(60) Provisional application No. 63/595,083, filed on Nov. 1, 2023.

(51) Int. Cl. G06Q 20/40; G06F 21/53

(52) U.S. Cl. CPC G06Q 20/401; G06F 21/53

(57) ABSTRACT

Systems and methods for routing, operating on sensitive data, performing risk assessments with respect to, and/or otherwise securely processing transactions. In some embodiments, an execution module executing in a secure environment may receive a data structure associated with a proposed transaction, the data structure comprising at least one non-sensitive expression representing sensitive data regarding the proposed transaction. The execution module may evaluate the at least one non-sensitive expression to obtain the sensitive data, and may use the sensitive data to construct an application programming interface (API) message to be submitted to a transaction processing gateway to request processing of the proposed transaction.

### BACKGROUND

The Payment Card Industry Security Standards Council (PCI SSC) establishes security standards, such as the Payment Card Industry Data Security Standard (PCI DSS), that govern how cardholder data (CHD) may be stored, processed, and/or transmitted.

Under the PCI DSS, an entity that handles a high volume of transactions may be subject to a rigorous audit to ensure that all security requirements are met. For instance, a qualified security assessor (QSA) certified by the PCI DSS may review information security controls, policies, and/or practices for the entity's cardholder data environment (CDE). Such an audit may be repeated at a suitable frequency (e.g., annually) to confirm on-going compliance.

Moreover, the entity may be required to adopt certain software development practices. For instance, a code review may be performed before newly developed software code is deployed in a CDE. Such software code may be reviewed to identify vulnerabilities such as buffer overflow, Structured Query Language (SQL) injection, cross-site scripting, etc.

### SUMMARY

Systems and methods are provided for routing transactions and/or performing risk assessments.

Additionally, or alternatively, a computer-implemented method is provided for transaction processing, the method comprising acts of: receiving a data structure associated with a proposed transaction, the data structure comprising at least one non-sensitive expression representing sensitive data regarding the proposed transaction; evaluating, within a secure environment, the at least one non-sensitive expression to obtain the sensitive data; using the sensitive data to construct an application programming interface (API) message to be submitted to a transaction processing gateway to request processing of the proposed transaction.

In accordance with some embodiments, a system is provided, comprising at least one processor and at least one computer-readable storage medium having stored thereon instructions which, when executed, program the at least one processor to perform any of the methods described herein.

In accordance with some embodiments, at least one computer-readable storage medium is provided, having stored thereon instructions which, when executed, program at least one processor to perform any of the methods described herein.

### BRIEF DESCRIPTION OF DRAWINGS

FIG. 1A shows an illustrative transaction ecosystem 100, in accordance with some embodiments.

FIG. 1B shows an illustrative transaction routing system 150, in accordance with some embodiments.

FIG. 2A shows an illustrative transaction processing system 200A, in accordance with some embodiments.

FIG. 2B shows another illustrative transaction processing system 200B, in accordance with some embodiments.

FIG. 2C shows another illustrative transaction processing system 200C, in accordance with some embodiments.

FIG. 3A shows an illustrative data structure 300A (or a portion thereof), in accordance with some embodiments.

FIG. 3B shows another illustrative data structure 300B (or a portion thereof), in accordance with some embodiments.

FIG. 4 shows an illustrative risk assessment module 400, in accordance with some embodiments.

FIG. 5 shows, schematically, an illustrative computer 1000 on which any aspect of the present disclosure may be implemented.

### DETAILED DESCRIPTION

Aspects of the present disclosure relate to systems and methods for transaction processing. In some embodiments, techniques are provided for routing transactions through different gateways, for example, to improve efficiency and/or reliability. Additionally, or alternatively, techniques are provided for performing risk assessments in real time, and/or processing transactions dynamically based on respective risk assessments.

Additionally, or alternatively, techniques are provided for reducing an attack surface of a computing environment that handles sensitive data. For instance, the inventors have recognized and appreciated that it may be beneficial to eliminate, from a CDE, software logic that does not handle CHD, or to reduce an amount of such software logic running in the CDE. This may improve security, and/or reduce development and/or maintenance overhead.

However, the inventors have also recognized and appreciated that many different types of operations may involve access to CHD. Accordingly, in some embodiments, techniques are provided for isolating software logic that depends on CHD from software logic that does not.

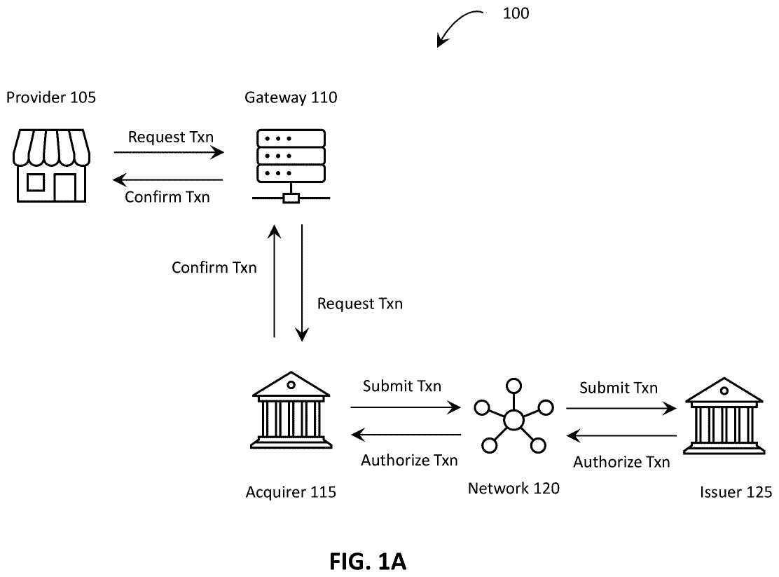

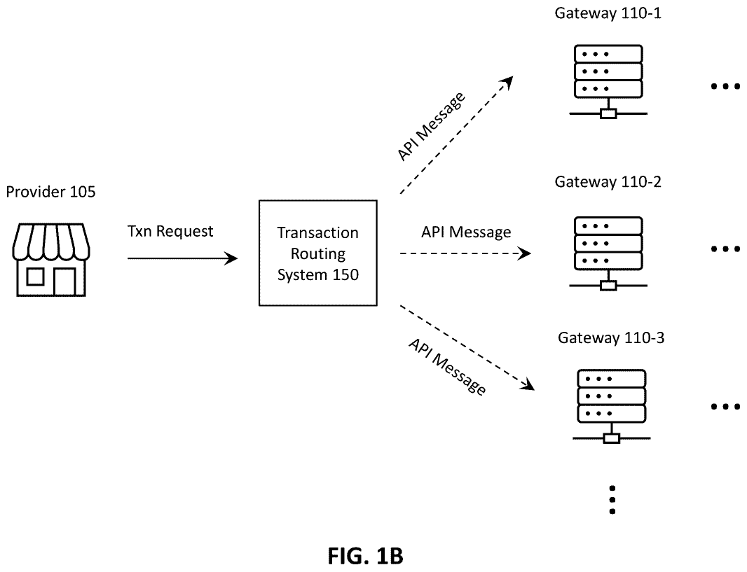

FIG. 1A shows an illustrative transaction ecosystem 100, in accordance with some embodiments. In this example, the transaction ecosystem 100 includes a plurality of entities involved in a payment transaction. For instance, a provider 105 may send a request to a gateway 110 to initiate a transaction. The gateway 110 may obtain pertinent information from the request (e.g., a transaction amount, a payment card number, a payment card expiration date, a card verification value, a cardholder name, a cardholder address, a cardholder email, a cardholder phone number, etc.), and may in turn send a request to a payment processor, such as an acquirer 115.

In some embodiments, the gateway 110 may be provided by a payment facilitator, which may maintain a merchant account with the acquirer 115. The provider 105 may be a sub-merchant that accepts payments via the payment facilitator's merchant account.

However, it should be appreciated that aspects of the present disclosure are not limited to providing the gateway 110 in any particular manner. In some embodiments, the gateway 110 may be provided by the acquirer 115 or some other payment processor. Additionally, or alternatively, the provider 105 may have a merchant account directly with the acquirer 115.

In some embodiments, in response to receiving the request from the gateway 110, the acquirer 115 may submit a transaction to a network 120 for authorization. For instance, the acquirer 115 may determine a payment card type based on information obtained from the request (e.g., the payment card number), and may submit the transaction to a corresponding payment network.

In some embodiments, the network 120 may submit the transaction to an issuer 125 for authorization. For instance, the network 120 may use the payment card number for the transaction to determine an appropriate issuer.

The issuer 125 may determine whether to authorize the transaction in any suitable manner. For instance, the issuer 125 may check the transaction amount against an available amount for an account associated with the payment card number for the transaction. Additionally, or alternatively, the issuer 125 may check the transaction amount against a one-time transaction limit associated with the payment card number. Additionally, or alternatively, the issuer 125 may check the transaction amount and one or more prior transaction amounts (e.g., occurring on the same day) against a cumulative transaction limit (e.g., a cumulative daily limit) associated with the payment card number.

In some embodiments, if the transaction is authorized, the issuer 125 may so inform the acquirer 115 via the network 120. In response, the acquirer 115 may provide a confirmation to the provider 105 via the gateway 110. Additionally, or alternatively, the acquirer 115 may settle the transaction with the issuer 125 (e.g., by batching all transactions authorized on each business day), and may credit a merchant account associated with the transaction (e.g., a merchant account of a payment facilitator, for further credit to the provider 105, or a merchant account of the provider 1 05 itself).

As discussed above, security standards such as the PCI DSS impose a significant burden on entities that handle CHD. For instance, an entity may be subject to periodic audits and/or software development lifecycle requirements. If the provider 105 is a small entity, the provider 105 may lack resources to comply with these security requirements. As a result, the provider 105 may rely on a payment facilitator or a payment processor to provide appropriate hardware (e.g., point-of-sale, or POS, terminals) and/or software (e.g., plug-ins to ecommerce platform software, or stand-alone software packages) to interact with the gateway 110.

The inventors have recognized and appreciated that, while multiple gateways may be available, each gateway may have a different application programming interface (API). It may be burdensome and/or costly to acquire and deploy multiple sets of hardware and/or software to interact with respective gateways. Therefore, the provider 105 may use only one gateway (e.g., the gateway 110) to process payments. This may result in reduced performance (e.g., when there are spikes in transaction volume at the gateway 110), reduced reliability (e.g., having the gateway 110 as a single point of failure), and/or increased costs (e.g., due to inability to switch to a gateway with lower transaction fees).

Accordingly, in some embodiments, techniques are provided for routing transactions through different gateways. This may improve performance and/or reliability, and/or reduce costs.

FIG. 1B shows an illustrative transaction routing system 150, in accordance with some embodiments. In this example, the transaction routing system 150 may be configured to interact with multiple gateways 110-1, 110-2, 110-3, . . . , where each gateway may have a different API.

For instance, the transaction routing system 150 may be configured to receive a transaction request from a provider (e.g., the illustrative provider 105 in the example of FIG. 1A), and obtain pertinent information from the request (e.g., a transaction amount, a payment card number, a payment card expiration date, a card verification value, a cardholder name, a cardholder address, a cardholder email, a cardholder phone number, etc.). The transaction routing system 150 may then select one of the gateways 110-i (i=1, 2, 3, . . . ), and may construct an API message accordingly.

The transaction routing system 150 may select a gateway in any suitable manner. In some embodiments, the provider 105 may indicate a plurality of approved gateways (e.g., a list of gateways ordered by preference). If a transaction request sent to an approved gateway (e.g., a most preferred gateway) is unsuccessful, the transaction routing system 150 may contact another approved gateway (e.g., a next preferred gateway). In this manner, reliability may be improved.

Additionally, or alternatively, the transaction routing system 150 may apply one or more selection criteria based on current information, such as response time, failure rate, transaction fee (e.g., according to a dynamic fee structure), etc. In this manner, the transaction routing system 150 may facilitate load balancing among the gateways 110-1, 110-2, 110-3, . . . . This may reduce failures and subsequent re-tries, thereby reducing consumption of resources such as power and communication bandwidth.

In some embodiments, the transaction routing system 150 may provide a unified API to the provider 105, regardless of how many gateway(s) may be reached. For instance, the provider 105 may acquire and deploy only one set of hardware (e.g., POS terminals) and/or software (e.g., a plug-in to ecommerce platform software, or a stand-alone software package) for interacting with the transaction routing system 150. This may reduce costs and/or operational burden for the provider 105.

It should be appreciated that the techniques introduced above and/or described below may be implemented in any of numerous ways, as these techniques are not limited to any particular manner of implementation. Examples of implementation details are provided herein solely for purposes of illustration. Furthermore, the techniques described herein may be used individually or in any suitable combination, as aspects of the present disclosure are not limited to any particular technique or combination of techniques.

For instance, aspects of the present disclosure are not limited to routing transactions through different gateways. In some embodiments, one or more of the techniques described herein may be used in connection with an individual gateway.

Moreover, although CHD is mentioned herein as an example of sensitive data, it should be appreciated that aspects of the present disclosure are not so limited. In some embodiments, one or more of the techniques described herein may be used to protect other type of sensitive data, which may be data protected under any law, government or industry regulation, internal policy of an entity, etc.

The inventors have recognized and appreciated it may be desirable to develop transaction processing software in an extensible manner. For instance, although different gateways may have different APIs, software logic for generating API messages for such gateways may share certain commonalities. Accordingly, in some embodiments, logic that is common across different gateways may be implemented by a shared software module, whereas logic that is specific to each gateway may be implemented by a separate software module corresponding to that gateway.

In this manner, code duplication may be reduced, which may allow more efficient development, testing, execution, maintenance, and/or auditing. This, in turn, may reduce errors and/or improve security. Additionally, or alternatively, software logic for generating API messages for a new gateway may be added with a reduced level of effort.

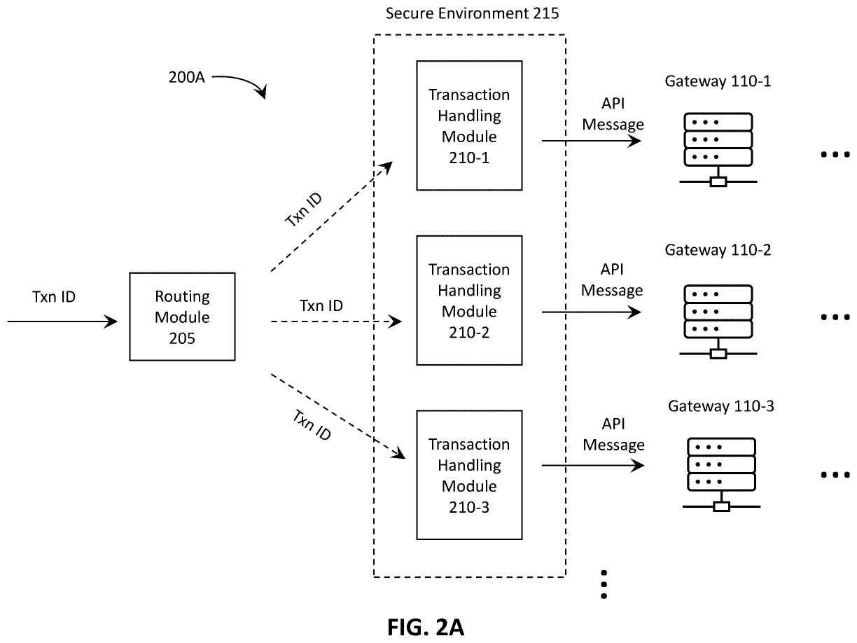

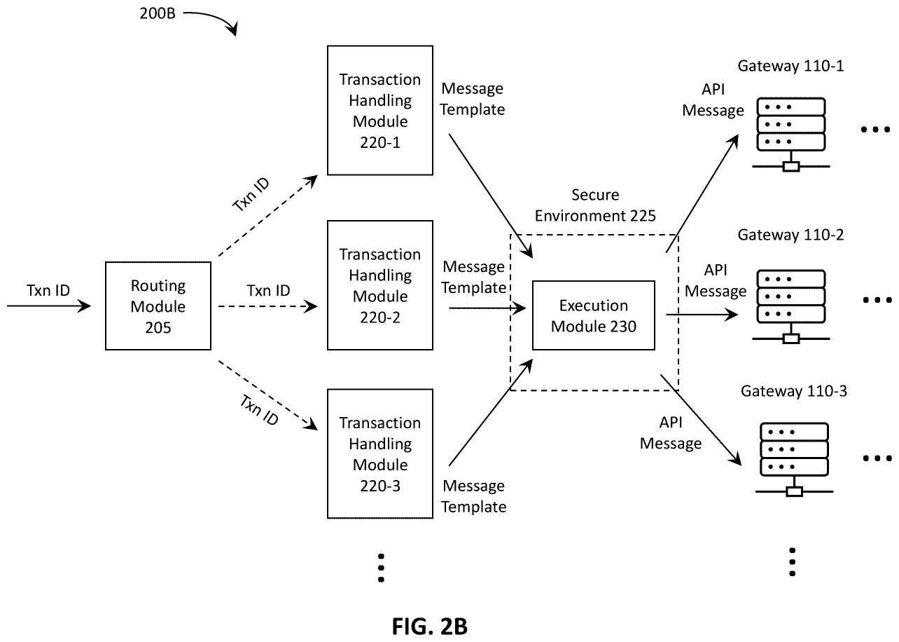

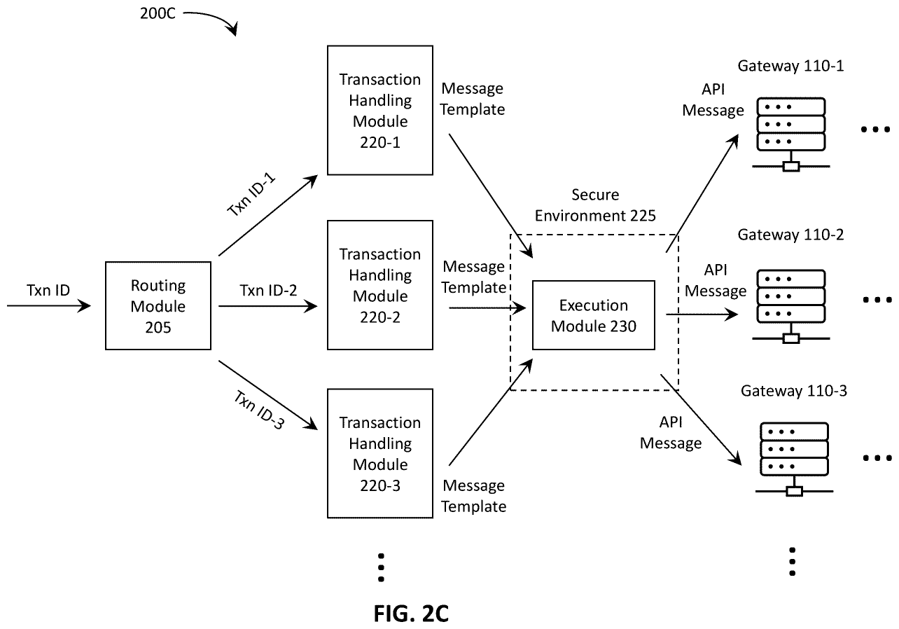

FIG. 2A shows an illustrative transaction processing system 200A, in accordance with some embodiments. In this example, the transaction processing system 200A includes a routing module 205 and multiple transaction handling modules 210-1, 210-2, 210-3, . . . . Each transaction handling module 210-i (i=1, 2, 3, . . . ) may be configured to interact with a respective one of the illustrative gateways 110-1, 110-2, 110-3, . . . in the example of FIG. 1B. For instance, each transaction handling module 210-i (i=1, 2, 3, . . . ) may be configured to generate transaction requests according to an API of the gateway 110-i.

In some embodiments, the routing module 205 may include software logic that is common across different gateways, whereas each transaction handling module 210-i (i=1, 2, 3, . . . ) may include logic that is specific to the gateway 110-i. However, it should be appreciated that aspects of the present disclosure are not limited to distributing functionalities within the transaction processing system 200A in any particular manner.

The routing module 205 may make routing decisions in any suitable manner. For instance, the routing module 205 may use one or more of the techniques described above in connection with the illustrative transaction routing system 150 in the example of FIG. 1B to select one of the gateways 110-i (i=1, 2, 3, . . . ).

In some embodiments, the transaction handling modules, 210-1, 210-2, 210-3, . . . may be deployed in a secure environment 215. The secure environment 215 may satisfy one or more requirements set out by a security standard, such as the PCI DSS. For instance, all payment card numbers stored anywhere in the secure environment 215 may be rendered unreadable (e.g., via strong cryptography; see, e.g., Requirement 3 in the PCI DSS v3.2.1 Quick Reference Guide, available at https://listings.pcisecuritystandards.org/documents/PCI_DSS-QRG-v3_2_1.pdf.). Additionally, or alternatively, the secure environment 215 may provide data confidentiality (e.g., protecting data from unauthorized access by an entity outside the secure environment 215) and/or code integrity (e.g., protecting code from unauthorized modification by an entity outside the secure environment 215).

By contrast, the routing module 205 may be deployed outside the secure environment 215. Accordingly, the transaction handling modules, 210-1, 210-2, 210-3, . . . may handle sensitive data, whereas the routing module 205 may not. In some embodiments, sensitive data may be considered sensitive even in encrypted form. In other embodiments, only sensitive data in unencrypted form may be considered sensitive, whereas sensitive data in encrypted form may be considered non-sensitive.

Thus, in some embodiments, the routing module 205 may receive, as input, a non-sensitive identifier for a transaction. For instance, the transaction processing system 200A may process an incoming transaction request by assigning the non-sensitive identifier to the transaction, and/or creating one or more entries in a transaction database (not shown in FIG. 2A), where the one or more database entries may be associated with the non-sensitive identifier. However, it should be appreciated that aspects of the present disclosure are not limited to obtaining the non-sensitive identifier in any particular manner. In some embodiments, the non-sensitive identifier may be extracted from the transaction request, or received from another source.

In some embodiments, the routing module 205 may use the transaction identifier to retrieve non-sensitive information about the transaction, for example, from the transaction database. Examples of non-sensitive information include, but are not limited to, a transaction amount, a payment card type, one or more approved gateways, etc. The routing module 205 may use such information to select a gateway 110-i (i=1, 2, 3, . . . ), and may pass the transaction identifier to a corresponding transaction handling module 210-i.

In some embodiments, in response to receiving a transaction identifier from the routing module 205, the transaction handling module 210-i may use the transaction identifier to retrieve sensitive information about the transaction from the same transaction database, or a different transaction database (not shown in FIG. 2A). Examples of sensitive information include, but are not limited to, a payment card number, a payment card expiration date, a card verification value, a cardholder name, a cardholder address, a cardholder email, a cardholder phone number, etc. The transaction handling module 210-i may use such information to generate a transaction request according to an API of the gateway 110-i.

While certain implementation details are described above in connection with FIG. 2A, it should be appreciated that such details are provided solely for purposes of illustration. For instance, aspects of the present disclosure are not limited to providing a transaction identifier as input to the routing module 205. In some embodiments, the routing module 205 may receive, as input, a data structure containing non-sensitive information in unencrypted form and/or sensitive information in encrypted form, and may pass the data structure to the transaction handling module 210-i. The routing module 205 may not have access to a cryptographic key for decrypting the sensitive information, but the transaction handling module 210-i may have access to such a cryptographic key.

Additionally, or alternatively, the routing module 205 may be deployed in the secure environment 215, and may receive, as input, a data structure containing non-sensitive information and/or sensitive information in unencrypted form, and may pass the data structure to the transaction handling module 210-i.

The inventors have recognized and appreciated that, as more gateways become available, additional transaction handling modules may be deployed in the secure environment 215. This may increase an attack surface of the secure environment 215. Accordingly, in some embodiments, techniques are provided for reducing an amount of software code deployed in the secure environment 215, thereby reducing the attack surface.

For instance, the inventors have recognized and appreciated that some tasks of a transaction handling module may be performed without handling any sensitive data. As an example, the transaction handling module 210-i may be able to perform authentication and establish a secure communication channel with the gateway 110-i without handling any sensitive data. Accordingly, in some embodiments, software code that does not handle any sensitive data may be executed outside the secure environment 215.

The inventors have further recognized and appreciated that, while some software code may handle sensitive data, such software code's logic may be independent of the sensitive data being handled. For instance, a software routine may assemble and/or format a data structure (e.g., an API message) containing sensitive data, but the software routine may proceed in the same way regardless of what is stored in the data structure. Accordingly, in some embodiments, techniques are provided for transforming such software code into software code that may not handle any sensitive data.

FIG. 2B shows another illustrative transaction processing system 200B, in accordance with some embodiments. In this example, the transaction processing system 200B includes the illustrative routing module 205 in the example of FIG. 2A, as well as multiple transaction handling modules 220-1, 220-2, 220-3, . . .

In some embodiments, the transaction handling modules 220-1, 220-2, 220-3, . . . may be similar to the illustrative transaction handling modules 210-1, 210-2, 210-3, . . . in the example of FIG. 2A. For instance, each transaction handling module 220-i (i=1, 2, 3, . . . ) may be configured to generate transaction requests according to an API of the illustrative gateway 110-i in the example of FIG. 1B.

However, unlike the transaction handling modules 210-1, 210-2, 210-3, . . . , which may be deployed in the illustrative secure environment 215 in the example of FIG. 2A, the transaction handling modules 220-1, 220-2, 220-3, . . . may not handle any sensitive data, and therefore may be deployed outside a secure environment 225.

The inventors have recognized and appreciated various advantages of having transaction handling modules that do not handle sensitive data. For instance, having less software code in the secure environment 225 may reduce a number of attack vectors that may be exploited to gain access to the secure environment 225. Moreover, less software code may be subject to security audits or software development lifecycle requirements, which may reduce costs and/or operational burden.

Accordingly, in some embodiments, instead of creating and/or manipulating data structures that contain sensitive data, the transaction handling modules 220-1, 220-2, 220-3, . . . may create and/or manipulate data structures that do not contain sensitive data.

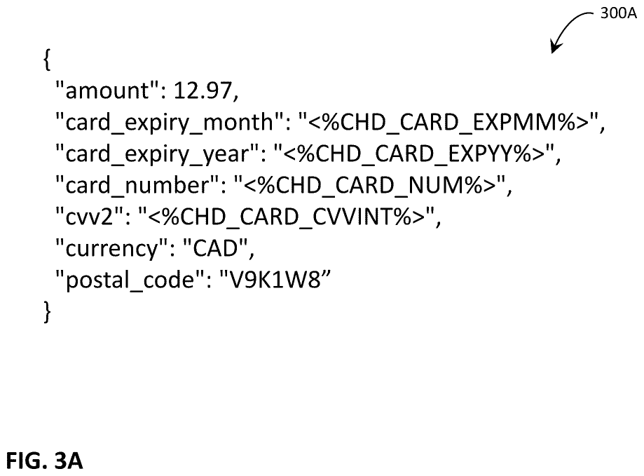

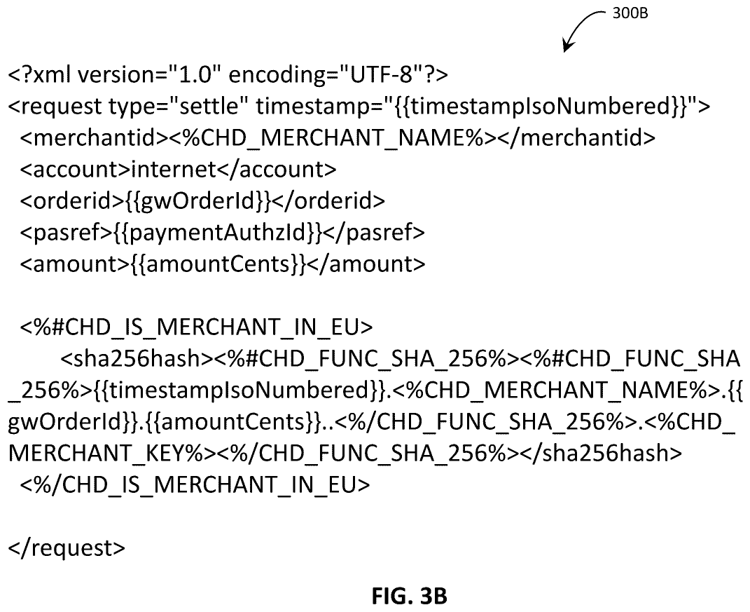

FIG. 3A shows an illustrative data structure 300A (or a portion thereof), in accordance with some embodiments. For instance, the data structure 300A may be a data structure for an API message for a transaction, and may be generated by the illustrative transaction handling module 220-i (i=1, 2, 3, . . . ) in the example of FIG. 2B according to an API of the illustrative gateway 110-i in the example of FIG. 1B.

In the example of FIG. 3A, the gateway 110-i may be configured to receive API messages in a JSON format. Additionally, or alternatively, the gateway 110-i may be configured to process an API message having one or more designated fields, such as amount, card expiry month, card expiry year, card number, card verification value, currency, postal code, etc. Some fields may contain non-sensitive data, such as amount, currency, postal code, etc. Other fields may contain sensitive data, such as card expiry month, card expiry year, card number, card verification value, etc.

In some embodiments, the transaction handling module 220-i may be deployed outside the secure environment 225 in the example of FIG. 2B, and therefore may not have access to sensitive data. Accordingly, non-sensitive fields in the data structure 300A may be populated with actual data pertaining to the transaction (e.g., 12.97 for amount, CAD for currency, V9K1W8 for postal code, etc.), whereas sensitive fields may be populated with non-sensitive expressions (e.g., <% CHD_CARD_EXPMM%> for card expiry month, <% CHD_CARD_EXPYY%> for card expiry year, <% CHD_CARD_NUM%> for card number, <% CHD_CARD_CVVINT%> for card verification value, etc.). As described below, such a non-sensitive expression may be instantiated with sensitive data within the secure environment 225 in the example of FIG. 2B.

A data structure (or a field thereof) having at least one non-sensitive expression to be instantiated with sensitive data is sometimes referred to herein as a “partially instantiated” data structure (or field).

In some embodiments, a non-sensitive expression representing sensitive data may have a designated format. For instance, such an expression may start with a selected pattern of one or more characters (e.g., “<%”), and/or end with a selected pattern of one or more characters (e.g., “%>”). However, it should be appreciated that aspects of the present disclosure are not limited to delimiting non-sensitive expressions in any particular manner, or at all.

Referring again to the example of FIG. 2B, the transaction handling module 220-i may output the data structure 300A to an execution module 230 for further processing. The execution module 230 may be deployed in the secure environment 225, and therefore may have access to sensitive data.

In some embodiments, the execution module 230 may parse data structures to identify non-sensitive expressions representing sensitive data. Additionally, or alternatively, the execution module 230 may evaluate the identified non-sensitive expressions using sensitive data, and/or populate the data structures with evaluation results.

For instance, the execution module 230 may search the data structure 300A in the example of FIG. 3A for a selected pattern indicating a start of a non-sensitive expression (e.g., “<%”) and/or a selected pattern indicating an end of a non-sensitive expression (e.g., “%>”), thereby identifying the non-sensitive expressions <% CHD_CARD_EXPMM%>, <% CHD_CARD_EXPYY%>, <% CHD_CARD_NUM%>, <% CHD_CARD_CVVINT%>, etc.

In some embodiments, the execution module 230 may evaluate the identified non-sensitive expressions. For instance, the execution module 230 may include a lookup table that maps non-sensitive expressions to corresponding sensitive data. Additionally, or alternatively, the lookup table may map non-sensitive expressions to database queries for retrieving corresponding sensitive data from a database in the secure environment 225, and the execution module 230 may execute such queries (e.g., based on a transaction identifier received from the routing module 205).

In some embodiments, sensitive data may be stored in a database in encrypted form. Accordingly, the execution module 230 may use one or more first cryptographic keys to decrypt the retrieved sensitive data. Additionally, or alternatively, the execution module 230 may replace each non-sensitive expression in the data structure 300A with the corresponding sensitive data (in decrypted form), thereby obtaining an API message. Additionally, or alternatively, the execution module 205 may use one or more second cryptographic keys to encrypt the API message for transmission.

The one or more second cryptographic keys used to encrypt the API message may be different from the one or more first cryptographic keys used to decrypt the sensitive data. For instance, the API message may be encrypted in such a way that only an intended recipient may be able to decrypt the API message (e.g., with a shared secret key established between the secure environment 225 and the intended recipient, for example, using symmetric-key cryptography with a trusted third party, or asymmetric-key cryptography).

In some embodiments, the execution module 230 may send the encrypted API message to an appropriate gateway, such as the gateway 110-i. For instance, the execution module 230 may receive, from the routing module 205 or the transaction handling module 220-i, a Uniform Resource Locator (URL) for the gateway 110-i. Additionally, or alternatively, the execution module 230 may receive, from the routing module 205 or the transaction handling module 220-i, a gateway identifier for the gateway 110-i, and may use the gateway identifier to look up a URL.

Additionally, or alternatively, the execution module 230 may receive, from the routing module 205 or the transaction handling module 220-i, both a gateway identifier and a URL for the gateway 110-i, and may use the gateway identifier to confirm that the URL is correct. For instance, the execution module 230 may use the gateway identifier to look up one or more domains associated with the gateway 110-i, and may confirm whether the URL points to one of the associated domain(s). However, it should be appreciated that aspects of the present disclosure are not limited to performing any particular security check with respect to a gateway, or any security check at all. In some embodiments, each gateway may have one or more associated security checks.

The inventors have recognized and appreciated that, even if a software routine's logic may depend on sensitive data, it may be possible to isolate such dependency to a small portion of the logic. Accordingly, in some embodiments, techniques are provided for factoring out software logic that may depend on sensitive data, thereby obtaining software code that may not handle any sensitive data.

FIG. 3B shows another illustrative data structure 300B (or a portion thereof), in accordance with some embodiments. Like the data structure 300A in the example of FIG. 3A, the data structure 300B may be a partially instantiated data structure for an API message for a transaction, and may be generated by the illustrative transaction handling module 220-i (i=1, 2, 3, . . . ) in the example of FIG. 2B according to an API of the illustrative gateway 110-i in the example of FIG. 1B.

In the example of FIG. 3B, the gateway 110-i may be configured to receive API messages in XML format. Additionally, or alternatively, the gateway 110-i may be configured to process an API message having one or more designated fields, such as merchant identifier, account type, order identifier, payment reference, amount, hash, etc. Some fields may contain non-sensitive data, such as account type, order identifier, payment reference, amount, etc. Other fields may contain sensitive data, such as merchant identifier, hash, etc.

In some embodiments, the transaction handling module 220-i may be deployed outside the secure environment 225 in the example of FIG. 2B, and therefore may not have access to sensitive data. Accordingly, non-sensitive fields in the data structure 300B may be populated with actual data (e.g., stored in variables indicated by double braces), whereas sensitive fields in the data structure 300B may be populated with non-sensitive expressions, such as <% CHD_MERCHANT_NAME%> for merchant identifier, and the following for hash.

<%#CHD_FUNC_SHA_256%><%#CHD_FUNC_SHA_256%>{{timestampIsoNumber ed}}.<%CHD_MERCHANT_NAME%>{{gwOrderId}}.{{amountCents}} . .<%/CHD_F UNC_SHA_256%>.<%CHD_MERCHANT_KEY%><%/CHD_FUNC_SHA_256%>

In some embodiments, a non-sensitive expression may represent a sensitive value obtained by applying one or more functions to one or more other sensitive values and/or one or more non-sensitive values. For instance, the above non-sensitive expression may represent a hash value obtained by applying a hash function (e.g., SHA-256) to a result of concatenating one or more sensitive values (e.g., another hash value, cardholder data, etc.). The other hash value may in turn be obtained by applying a hash function (e.g., SHA-256) to a result of concatenating one or more sensitive values (e.g., a merchant identifier, etc.) and/or one or more non-sensitive values (e.g., a time stamp, an order identifier, an amount, etc.).

Additionally, or alternatively, a non-sensitive expression, such as the above expression for hash, may be generated based on the API of the gateway 110-i. For instance, each of the illustrative gateways 110-1, 110-2, 110-3, . . . in the example of FIG. 1B may have respective API specifications. The API specification of the gateway 110-i may indicate one or more functions (e.g., hashing and/or one or more other transformations), one or more sensitive and/or non-sensitive values to which the one or more functions are to be applied, an order in which the one or more functions are to be applied to the one or more sensitive and/or non-sensitive values, etc.

In some embodiments, the data structure 300B may include a field that is conditional upon a sensitive value represented by a non-sensitive expression. For instance, the hash field may only be present if a sensitive Boolean value represented by a non-sensitive expression, <% CHD_IS_MERCHANT_IN_EU%>, is true.

Referring again to the example of FIG. 2B, the transaction handling module 220-i may output the data structure 300B to the illustrative execution module 230 for further processing.

The execution module 230 may do so in any suitable manner, for instance, as described above in connection with the example of FIG. 3A. As an example, the execution module 230 may search the data structure 300B for a selected pattern indicating a start of a non-sensitive expression (e.g., “<%”) and/or a selected pattern indicating an end of a non-sensitive expression (e.g., “%>”), thereby identifying the non-sensitive expressions <%CHD_MERCHANT_NAME % >, <%CHD_IS_MERCHANT_IN_EU%>, <%#CHD_FUNC_SHA_256% >, <%/CHD_FUNC_SHA_256%>, <%CHD_MERCHANT_KEY%>, etc.

In some embodiments, the execution module 230 may examine the identified non-sensitive expressions to identify one or more functions. For instance, the execution module 230 may search for one or more selected patterns, such as “<%#CHD_FUNC_SHA_256%>” indicating a selected hash function. Additionally, or alternatively, the execution module 230 may search for a selected pattern indicating one or more arguments of a function (e.g., one or more expressions between “<%#CHD_FUNC_SHA_256%>” and “<%/CHD_FUNC_SHA_256%>”).

Additionally, or alternatively, the execution module 230 may apply an identified function to one or more identified arguments, where each argument may be a non-sensitive value (e.g., stored in a variable indicated by double braces), a sensitive value (e.g., retrieved from a database and/or decrypted), or a result of applying another identified function to one or more other identified arguments.

As described above, the non-sensitive expressions in the data structure 300B may be based on the API of the gateway 110-i. Thus, by processing non-sensitive expressions with different program logic encoded therein, the execution module 230 may use the same software code to execute different functions corresponding, respectively, to different gateways. This may reduce an amount of software code running in the secure environment 225, thereby reducing an attack surface and improving security.

The inventors have recognized and appreciated that, in some instances, it may be desirable to decompose a transaction into a plurality of sub-transactions. For instance, the sub-transactions may have respective amounts that add up to an amount of the transaction, or a slightly higher amount (e.g., to reflect additional resources expended to process multiple sub-transactions, as opposed to a single transaction). The respective amounts may be equal, or different.

A given transaction may be decomposed into any suitable number of sub-transactions, for example, two, three, four, five, etc. Additionally, or alternatively, the sub-transactions may involve different payment cards, or the same payment card. Additionally, or alternatively, the sub-transactions may be processed at different times (e.g., sequentially at selected intervals via a buy-now-pay-later arrangement), or at the same time. However, it should be appreciated that aspects of the present disclosure are not limited to decomposing a transaction into a plurality of sub-transactions in any manner, or at all.

The inventors have further recognized and appreciated that it may be desirable to route different sub-transactions through different gateways.

FIG. 2C shows another illustrative transaction processing system 200C, in accordance with some embodiments. For instance, the transaction processing system 200C may be similar to the illustrative transaction processing system 200B in the example of FIG. 2B.

In the example of FIG. 2C, the transaction processing system 200C may, in response to receiving a request for a transaction, generate a plurality of sub-transactions. The sub-transactions may have respective transaction identifiers, which may be different from an identifier of the original transaction. Additionally, or alternatively, the routing module 205 may route the sub-transactions through different gateways, such as the illustrative gateways 110-1, 110-2, 110-3, . . . in the example of FIG. 1B.

The routing module 205 may select a gateway for a sub-transaction in any manner. In some embodiments, a gateway may be selected independently for each sub-transaction (e.g., as described above in connection with the example of FIG. 1B). Additionally, or alternatively, a selection for a first sub-transaction may influence a selection for a second sub-transaction. For instance, if a highest ranked gateway is selected, from a list of preferred gateways, for an earlier sub-transaction, but produces an undesirable outcome (e.g., a transaction speed lower than a selected threshold, a number of retries higher than a selected threshold, a transaction fee higher than a selected threshold, a transaction denial, etc.), then a next gateway on the list may be selected for a later sub-transaction.

The inventors have recognized and appreciated that allowing sub-transactions of the same transaction to be routed through different gateways may improve performance and/or reliability, and/or reduce costs. For instance, a gateway may be selected for a later sub-transaction based on real-time formation, such as response time, failure rate, transaction fee (e.g., according to a dynamic fee structure), etc., regardless of how an earlier sub-transaction of the same transaction is routed. However, it should be appreciated that aspects of the present disclosure are not limited to routing sub-transactions of the same transaction through different gateways.

The inventors have further recognized and appreciated that, if a transaction is decomposed into a plurality of sub-transactions, and at least one of the sub-transactions is processed at a later time, there may be a risk that a later sub-transaction may be declined. Accordingly, in some embodiments, a risk assessment may be performed to determine whether to accept such a transaction for processing.

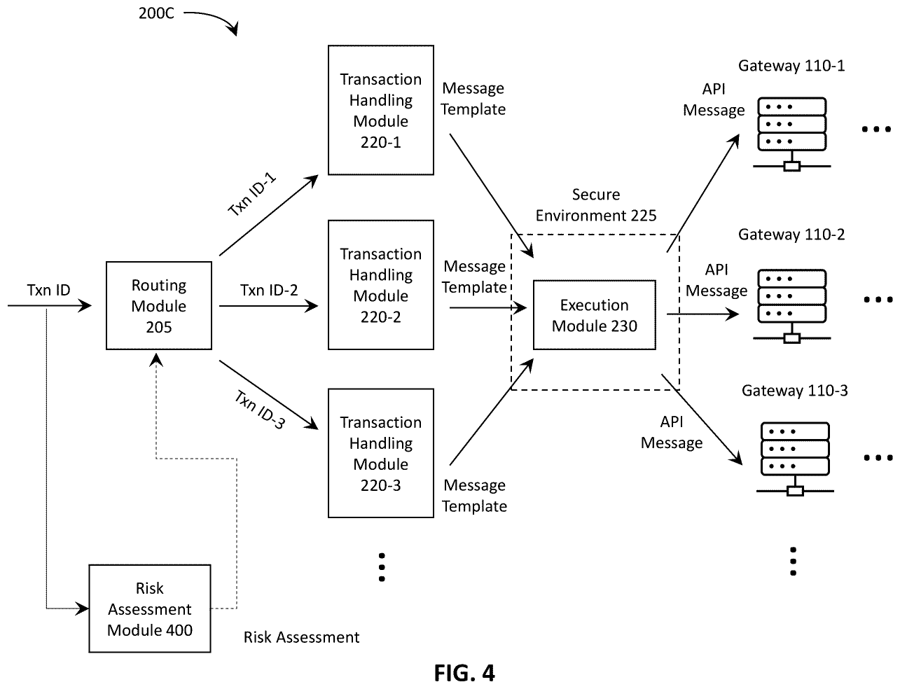

FIG. 4 shows an illustrative risk assessment module 400, in accordance with some embodiments. For instance, the risk assessment module 400 may execute in parallel with the illustrative transaction processing system 200C in the example of FIG. 2C.

In some embodiments, the routing module 205 may decompose a transaction into a plurality of sub-transactions, which may include a pre-authorization sub-transaction. The routing module 205 may submit the pre-authorization sub-transaction to a selected gateway, before submitting any other sub-transaction.

In some embodiments, while the pre-authorization sub-transaction is being processed, the risk assessment module 400 may assess a level of risk associated with the transaction. If the risk assessment module 400 determines that the transaction represents an acceptable level of risk, and the pre-authorization sub-transaction is successfully processed, the routing module 205 may proceed with one or more other sub-transactions. If, instead, the risk assessment module 400 determines that the transaction represents an unacceptably high level of risk, the routing module 205 may cancel the transaction, even if the pre-authorization sub-transaction is successfully processed.

The risk assessment module 400 may determine a level of risk in any suitable manner. For instance, the risk assessment module 400 may determine an overall risk score for the transaction based on one or more sub-scores (e.g., as a weighted sum of such sub-scores). Such sub-scores may relate to, respectively, different aspects of the transaction, such as a history of a cardholder initiating the transaction, a product or service to which the transaction pertains, a history of a vendor offering the product or service (e.g., the illustrative provider 105 in the example of FIG. 1A), etc.

Additionally, or alternatively, the risk assessment module 400 may apply one or more rules based on the risk score. As an example, the risk assessment module 400 may determine that the transaction represents an unacceptably high level of risk if a transaction amount is over a first selected threshold (e.g., $1,000) and the risk score is over is a second selected threshold (e.g., 750 on a scale of 1 to 1000).

The inventors have recognized and appreciated that it may be challenging to complete a risk assessment in real time. For instance, to compute a risk score, the risk assessment module 400 may access multiple remote APIs of data vendors (e.g., a different API for each sub-score). Even if such API calls are made in parallel, it may take several seconds (e.g., 3-6 seconds) to compute all sub-scores, combine such sub-scores into the overall score, and apply appropriate rules based on the overall score.

The inventors have further recognized and appreciated that, by performing risk assessment in parallel with pre-authorization, a total delay may be reduced. For instance, a pre-authorization sub-transaction may take several seconds (e.g., 2-5 seconds) to complete. If the pre-authorization sub-transaction fails, then the risk assessment may be irrelevant. If, instead, the pre-authorization sub-transaction is successful, the routing module 205 may wait for a short time (e.g., 1 second) for the risk assessment to be completed, and may proceed according to an outcome of the risk assessment.

In this manner, a transaction confirmation may be returned more quickly, which may improve user experience. However, it should be appreciated that aspects of the present disclosure are not limited to performing risk assessment in any particular manner, or at all.

The various modules described herein, including but not limited to the routing module 205, transaction handling module 220-i, execution module 230, and risk assessment module 400 each may comprise hardware and/or software to implement the applicable capability. For example, a capability may be implemented through a module having one or more processors executing computer code stored on one or more non-transitory computer-readable storage medium/media. In some embodiments, a capability is implemented at least in part through a module having dedicated hardware (e.g., an ASIC, an FPGA). In some embodiments, modules may share components. For example, a first function module and a second function module may both utilize a common processor (e.g., through time-share or multithreading), have computer executable code stored on a common computer storage medium (e.g., at different memory locations), and/or share computer executable code (e.g., a DLL).

In some instances, a module may be identified as a hardware module or a software module. A hardware module includes or shares the hardware for implementing the capability of the module. A hardware module may include software, that is, it may include a software module. A software module comprises information that may be stored, for example, on a non-transitory computer-readable storage medium. In some embodiments, the information may comprise instructions executable by one or more processors. In some embodiments, the information may be used at least in part to configure hardware such as an FPGA. The capability may be implemented, for example, by reading the software module from a storage medium and executing it with one or more processors, or by reading the software module from a storage medium and using the information to configure hardware.

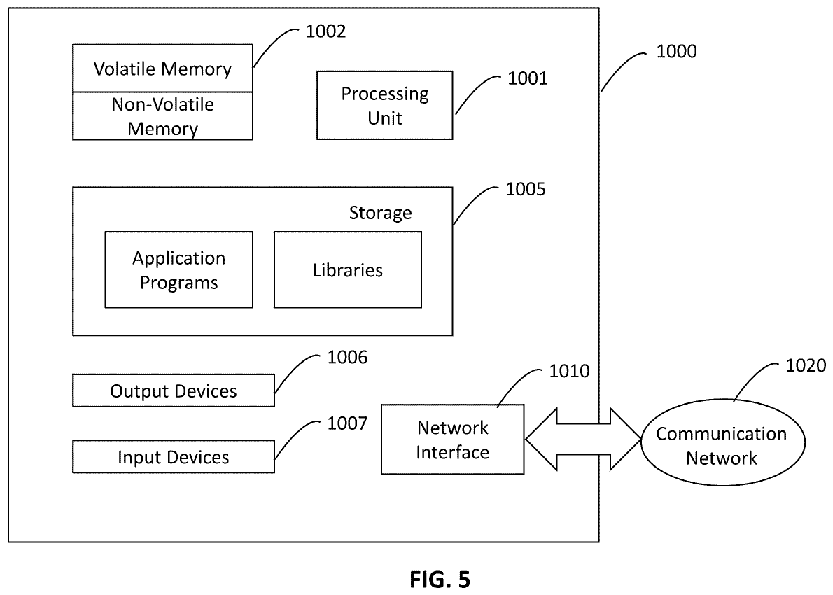

FIG. 5 shows, schematically, an illustrative computer 1000 on which any aspect of the present disclosure may be implemented.

In the example of FIG. 5, the computer 1000 includes a processing unit 1001 having one or more computer hardware processors and one or more articles of manufacture that comprise at least one non-transitory computer-readable medium (e.g., a memory 1002) that may include, for example, volatile and/or non-volatile memory. The memory 1002 may store one or more instructions to program the processing unit 1001 to perform any of the functions described herein. The computer 1000 may also include other types of non-transitory computer-readable media, such as a storage 1005 (e.g., one or more disk drives) in addition to the memory 1002. The storage 1005 may also store one or more application programs and/or resources used by application programs (e.g., software libraries), which may be loaded into the memory 1002. To perform any of the illustrative functionalities described herein, processing unit 1001 may execute one or more processor-executable instructions stored in the one or more non-transitory computer-readable media (e.g., the memory 1002, the storage 1005, etc.), which may serve as non-transitory computer-readable media storing processor-executable instructions for execution by the processing unit 1001.

The computer 1000 may have one or more input devices and/or output devices, such as devices 1006 and 1007 illustrated in FIG. 5. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1007 may include a microphone for capturing audio signals, and the output devices 1006 may include a display screen for visually rendering, and/or a speaker for audibly rendering, recognized text.

In the example of FIG. 5, the computer 1000 also includes one or more network interfaces (e.g., a network interface 1010) to enable communication via various networks (e.g., a network 1020). Examples of networks include local area networks (e.g., an enterprise network), wide area networks (e.g., the Internet), etc. Such networks may be based on any suitable technology operating according to any suitable protocol, and may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer-readable media) encoded with one or more programs that, when executed on one or more processors, perform methods that implement the various embodiments of the present disclosure described above. The computer-readable medium or media may be portable, such that the program or programs stored thereon may be loaded onto one or more different computers or processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium so that the locations convey how the fields are related. However, any suitable mechanism may be used to relate information in fields of a data structure, including through the use of pointers, tags, or other mechanisms that establish how the data elements are related.

Various features and aspects of the present disclosure may be used alone, in any combination of two or more, or in a variety of arrangements not specifically described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments. Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

What is claimed is:

1. A computer-implemented method for transaction processing, the method comprising acts of:
receiving a data structure associated with a proposed transaction, the data structure comprising at least one non-sensitive expression representing sensitive data regarding the proposed transaction;
evaluating, within a secure environment, the at least one non-sensitive expression to obtain the sensitive data; and
using the sensitive data to construct an application programming interface (API) message to be submitted to a transaction processing gateway to request processing of the proposed transaction.

2. The method of claim 1, wherein:
the data structure is generated by at least one software component executing outside the secure environment; and
the data structure is formatted according to an API specification of the transaction processing gateway.

3. The method of claim 1, wherein:
the act of evaluating the at least one non-sensitive expression comprises:
parsing the at least one non-sensitive expression to identify a first pattern indicating a selected function and one or more second patterns indicating, respectively, one or more arguments; and
applying the selected function to the one or more arguments to obtain the sensitive data.

4. The method of claim 3, wherein:
the at least one non-sensitive expression comprises a first non-sensitive expression;
the sensitive data comprises first sensitive data;
the one or more second patterns comprise a second non-sensitive expression representing second sensitive data regarding the proposed transaction;
the one or more arguments to which the selected function is applied comprise the second sensitive data; and
the act of evaluating the at least one non-sensitive expression further comprises retrieving the second sensitive data from a database within the secure environment.

5. A system comprising:
at least one processor; and
at least one computer-readable storage medium having stored thereon instructions which, when executed, program the at least one processor to perform a method comprising acts of:
receiving a data structure associated with a proposed transaction, the data structure comprising at least one non-sensitive expression representing sensitive data regarding the proposed transaction;
evaluating, within a secure environment, the at least one non-sensitive expression to obtain the sensitive data; and
using the sensitive data to construct an application programming interface (API) message to be submitted to a transaction processing gateway to request processing of the proposed transaction.

6. The system of claim 5, wherein:
the at least one processor is further programmed to execute at least one software component outside the secure environment;
the data structure is generated by the at least one software component executing outside the secure environment; and
the data structure is formatted according to an API specification of the transaction processing gateway.

7. The system of claim 5, wherein:
the act of evaluating the at least one non-sensitive expression comprises:
parsing the at least one non-sensitive expression to identify a first pattern indicating a selected function and one or more second patterns indicating, respectively, one or more arguments; and
applying the selected function to the one or more arguments to obtain the sensitive data.

8. The system of claim 7, wherein:
the at least one non-sensitive expression comprises a first non-sensitive expression;
the sensitive data comprises first sensitive data;
the one or more second patterns comprise a second non-sensitive expression representing second sensitive data regarding the proposed transaction;
the one or more arguments to which the selected function is applied comprise the second sensitive data; and
the act of evaluating the at least one non-sensitive expression further comprises retrieving the second sensitive data from a database within the secure environment.

9. At least one computer-readable storage medium having stored thereon instructions which, when executed, program at least one processor to perform a method comprising acts of:
receiving a data structure associated with a proposed transaction, the data structure comprising at least one non-sensitive expression representing sensitive data regarding the proposed transaction;
evaluating, within a secure environment, the at least one non-sensitive expression to obtain the sensitive data; and
using the sensitive data to construct an application programming interface (API) message to be submitted to a transaction processing gateway to request processing of the proposed transaction.

10. The at least one computer-readable storage medium of claim 9, wherein:
the instructions further program the at least one processor to execute at least one software component outside the secure environment;
the data structure is generated by the at least one software component executing outside the secure environment; and
the data structure is formatted according to an API specification of the transaction processing gateway.

11. The at least one computer-readable storage medium of claim 9, wherein:
the act of evaluating the at least one non-sensitive expression comprises:
parsing the at least one non-sensitive expression to identify a first pattern indicating a selected function and one or more second patterns indicating, respectively, one or more arguments; and
applying the selected function to the one or more arguments to obtain the sensitive data.

12. The at least one computer-readable storage medium of claim 11, wherein:
the at least one non-sensitive expression comprises a first non-sensitive expression;
the sensitive data comprises first sensitive data;
the one or more second patterns comprise a second non-sensitive expression representing second sensitive data regarding the proposed transaction;
the one or more arguments to which the selected function is applied comprise the second sensitive data; and
the act of evaluating the at least one non-sensitive expression further comprises retrieving the second sensitive data from a database within the secure environment.
